(19) United States
(12) Patent Application Publication
(10) Pub. No.: US 2006/0059174 A1
(43) Pub. Date: Mar. 16, 2006

(54) Apparatus, system, and method for locating an application compatible with a file

(75) Inventors: John Carl Mese, Cary, NC (US); Nathan J. Peterson, Raleigh, NC (US); Rod David Waltermann, Durham, NC (US); Arnold S. Weksler, Raleigh, NC (US)

Correspondence Address: KUNZLER & ASSOCIATES, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 10/942,270

(22) Filed: Sep. 16, 2004

(51) Int. Cl. G06F 17/30

(52) U.S. Cl. 707/100

(57) ABSTRACT

An apparatus, system, and method are disclosed for finding an application compatible with a file. An identification module is included to associate an identifier with a file within a computing device, the identifier configured to identify an application compatible with the file. An access module is included to access the identifier in response to selection of the file. A reference module is included to reference an application external to the computing device using the identifier. In an alternate embodiment, the access module accesses the identifier in response to selection of the file and failure to locate an application registered with the computing device compatible with the file.

### BACKGROUND OF THE INVENTION

1. Field of the Invention

This invention relates to identifying an application compatible with a file and more particularly relates to identifying an application compatible with a file in response to failure to locate an application that is compatible with the file and registered with the computing device where the file resides.

2. Description of the Related Art

Some computer operating systems use files with names that include a file extension. Typically, file extensions are the last characters in a file name after a period and are typically three characters. File extensions are typically used with a file to identify an application compatible with the file. Generally, when a file is saved, an application will add an extension to the chosen file name that is specific to the application.

Since file extensions are part of a file name, and users and computer operations may change a file name, a file extension may be changed or deleted. Many operating systems are dependent on file extensions to identify an application compatible with a file. In such a system, if the file extension of a file name is removed, when the file is selected to be opened the operating system cannot typically determine an application compatible with the file which will cause an error. A user accessing the file without knowledge of compatible applications will also be unable to determine an application compatible with the file.

If a file extension is changed, the new file extension may either be unrecognized by the operating system or by the user or may correspond to an application not compatible with the file. If a file extension corresponds with an application different than the application that created the file, the operating system may attempt to open the file with the application indicated by the extension, which may also result in an error. For example, if a file A is created by application X with an extension “.abc” and the extension is changed to “.xyz,” which corresponds to application Y, a computer system may try to open file A with application Y. Opening a file with an application not compatible with a file generally results in an error and may cause a computer to crash.

If an unrecognized extension is part of a file name or if the file extension is removed, the operating system typically will not be able to determine an application compatible with the file. When a file with an unrecognized or nonexistent file extension is selected, typically the operating system displays an error message. The resulting error message will typically simply ask the user to identify which application the user wishes to use to open the file from a list of applications registered with the operating system of the computer.

Alternatively, the error message may direct the user to a web address containing a list of known file extensions and corresponding applications where the user or software can search for a file extension matching that of the file. If an application creates a new file type with a new extension, a major disadvantage of a centrally located list of file extensions is that the list may not be updated for a period of time. The owner of the centrally located list of file extensions may not have an incentive to update the list and add the new file extension if the application that created the file with the new extension is a competitor to the owner of the list of extensions. In addition, the location of the list of extensions may be inaccessible for a period of time.

If the file extension is not found in the list of extensions, the user will not be able to identify an application compatible with the file. In addition, if the original file extension has been changed, consulting a list of file extensions generally will not identify the application that created the file.

Other computer systems use files having two parts: a data fork and a resource fork. The resource fork contains a file type code and a creator code. The file type code identifies the file type such as a data file, an executable file, etc. The creator code identifies an application that created the file. If an application compatible with a file is not registered with an operating system that relies on the resource fork, when the file is accessed the operating system will not be able to open the file and may send an error message.

The resource fork may also be stripped from a file by some applications. For example, a file attached to an email may have its resource fork stripped when the email is sent. Files with a resource fork may also have an extension and the extension may misidentify the file as one compatible with an application.

If a file with a resource fork is sent to a system requiring an extension, the file may be sent without an extension so a user or computer may not be able to identify an application compatible with the file. Similarly, if a file with an extension is sent to an operating system requiring a resource fork, the system may not be able to properly identify an application compatible with the file.

When a file is created, the application creating the file may include in the file information including the name and the version of the application. However, each application that includes such information typically uses a proprietary format and typically places the information in the file in a non-standard location known only to the application. The location of the identification information is not typically known by an operating system.

An application that creates a file may be able to open the file regardless of the kind of file extension or whether a file extension is included. However, if an application incompatible with the file attempts to open the file and the correct application is not accessible from the computer where the file resides, a user will not be able to open the file.

From the foregoing discussion, it should be apparent that a need exists for an apparatus, system, and method that finds an application compatible with a file regardless of the file extension. Beneficially, such an apparatus, system, and method would identify and locate an application compatible with a file when the computer or user fails to locate an application compatible with the file. The apparatus, system, and method would store information identifying applications compatible with a file on or accessible to the computer where the file resides rather than a central database on a web site. The apparatus, system, and method would store a preferred application compatible with the file and would give priority to the preferred application to open the file instead of allowing a non-preferred application to open the file based on the file's extension.

### SUMMARY OF THE INVENTION

The present invention has been developed in response to the present state of the art, and in particular, in response to the problems and needs in the art that have not yet been fully solved by currently available methods of finding an application compatible with a file. Accordingly, the present invention has been developed to provide an apparatus, system, and method for finding an application compatible with a file that overcome many or all of the above-discussed shortcomings in the art.

The apparatus for finding an application compatible with a file is provided with a logic unit containing a plurality of modules configured to functionally execute the necessary steps of finding an application compatible with a file. These modules in the described embodiments include an identification module that associates an identifier with a file within a computing device, where the identifier is configured to identify an application compatible with the file, an access module that accesses the identifier in response to selection of the file, and a reference module that references an application external to the computing device using the identifier.

In an alternate embodiment, the access module accesses the identifier in response to selection of the file and failure to locate an application registered with the computing device and compatible with the file. In another alternate embodiment, the reference module opens a window in response to the access module accessing the file, the window including a selection for retrieving the referenced application.

The reference module, in one embodiment, prompts a user to obtain the referenced application. In another embodiment, the reference module automatically installs the referenced application. In yet another embodiment, the reference module opens the file with the referenced application.

In a preferred embodiment, the referenced application comprises a preferred application. In another embodiment, the reference module references a second application compatible with the file using the identifier in addition to the preferred application. Preferably, code for implementing the identification module, the access module, and the reference module is free from code of the referenced application.

The identifier, in one embodiment, comprises a Uniform Resource Identifier (“URI”). In another embodiment, the URI references an external location accessible to the computing device, the external location supplying the referenced application.

In an alternate embodiment for finding an application compatible with a file is provided. The apparatus may be configured to include a storage module that stores a plurality of identifiers on a computing device where each identifier identifies an application and a location for the application compatible with a file. A pointer module is included that associates a pointer within a file with one of the identifiers external to the file. An access module is included that reads the pointer and accesses the associated identifier in response to selection of the file. A reference module is also included that references an application external to the computing device using the identifier. In an alternate embodiment, the access module accesses the identifier in response to selection of the file and failure to locate an application registered with the computing device and compatible with the file.

In one embodiment, the identifier comprises a Uniform Resource Identifier (“URI”) that references a web address accessible to the computing device for accessing the referenced application. In another embodiment, the reference module opens a window in response to the access module accessing the file, the window including a selection for retrieving the referenced application.

A system of the present invention is also presented for finding an application compatible with a file. The system may be embodied by a central processing unit (“CPU”), a data storage device, an input/output interface, a memory, and a communication bus to facilitate communication between the CPU, the memory, the data storage device, and the input/output interface. The memory includes an identification module that associates an identifier with a file within a computing device where the identifier identifies an application compatible with the file. The memory also includes an access module that accesses the identifier in response to selection of the file, and a reference module that references an application external to the computing device using the identifier. In particular, the access module, in one embodiment, accesses the identifier in response to selection of the file and failure to locate an application registered with the computing device and compatible with the file.

The system may further include a communications adapter coupled to the communication bus that communicates with a repository for the referenced application. In another embodiment, the identifier comprises a URI for referencing an external location accessible to the computing device, the external location supplying the referenced application. In another embodiment, the reference module opens a window in response to the access module accessing the file, the window including a selection for retrieving the referenced application.

A method of the present invention is also presented for finding an application compatible with a file. The method in the disclosed embodiments substantially includes the steps necessary to carry out the functions presented above with respect to the operation of the described apparatus and system. In one embodiment, the method includes associating an identifier with a file within a computing device, the identifier configured to identify an application compatible with the file, accessing the identifier in response to selection of the file, and referencing an application external to the computing device using the identifier.

In an alternate embodiment, accessing the identifier includes accessing the identifier in response to selection of the file and failure to locate an application registered with the computing device compatible with the file. In one embodiment, the identifier comprises a Uniform Resource Identifier (“URI”). In another embodiment, the URI references a web address accessible to the computing device for accessing the referenced application. In an alternate embodiment, referencing the application external to the computing device includes opening a window in response to accessing the file, the window including a selection for accessing the referenced application.

In a further embodiment, referencing the application external to the computing device includes prompting a user to obtain the identified application. In another embodiment, referencing the application external to the computing device includes automatically installing the referenced application. In yet another embodiment, referencing the application external to the computing device includes opening the file with the identified application.

In a preferred embodiment, referencing the application external to the computing device includes referencing a preferred application. In another embodiment, referencing the application external to the computing device also includes referencing a second application compatible with the file in addition to the preferred application. Preferably, code for associating an identifier with a file, accessing the identifier and referencing an application external to the computing device using the identifier is free from code of the referenced application.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for finding an application compatible with a file in accordance with the present invention;

FIG. 2 is a schematic block diagram illustrating one embodiment of an apparatus for finding an application compatible with a file in accordance with the present invention;

FIG. 3 is a schematic block diagram illustrating an alternate embodiment of an apparatus for finding an application compatible with a file in accordance with the present invention;

FIG. 4 is a schematic flow chart diagram illustrating one embodiment of a method for finding an application compatible with a file in accordance with the present invention;

FIG. 5 is a schematic flow chart diagram illustrating an alternate embodiment of a method for finding an application compatible with a file in accordance with the present invention;

FIG. 6 is a block diagram illustrating an example of one embodiment of an identifier in accordance with the present invention; and

FIG. 7 is a block diagram illustrating one embodiment of a display for retrieving a referenced application in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

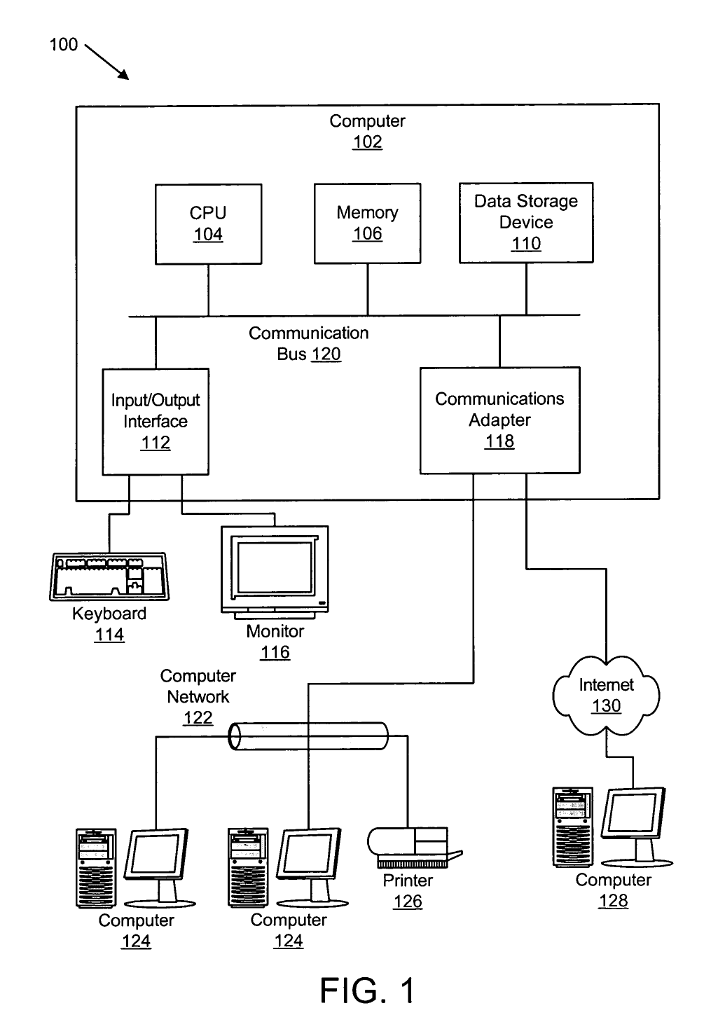

FIG. 1 depicts a schematic block diagram illustrating one embodiment of a system 100 for finding an application compatible with a file in accordance with the present invention. The system 100 comprises a computer 102. A computer as referenced herein may be embodied by a personal computer, a laptop computer, a workstation, a mainframe computer, a server, a hand held computer, or any other computing device that makes use of files.

In one embodiment, the computer 102 includes a CPU 104, a memory 106, a data storage device 110, an input/output interface 112 for connection to a keyboard 114 or a monitor 116, and a communications adapter 118, all of which are connected to a communication bus 120 configured to facilitate communication between devices.

The communications adapter 118, in one embodiment, is in communication with a computer network 122. The computer network 122 enables communication between a plurality of computers 124 and other peripheral devices such as a printer 126. The communication adapter 118 may also be in communication with other computers 128 through the Internet 130. In another embodiment, the communication adapter 118 communicates through a computer 124, such as a server, via the computer network 122 to another computer 128 through the Internet 130.

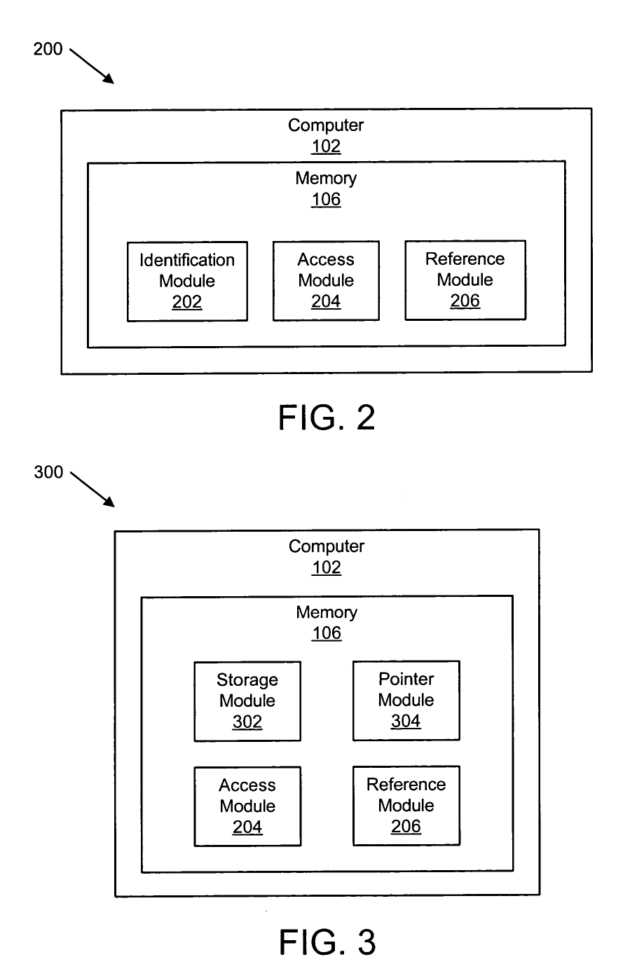

FIG. 2 is a schematic block diagram illustrating one embodiment of an apparatus 200 for finding an application compatible with a file in accordance with the present invention. The apparatus 200 comprises an identification module 202, access module 204, and reference module 206 loaded into memory 106 in the computer 102.

The identification module 202 is configured to associate an identifier with a file. The identifier may be a field in the file, a pointer to a table or other data structure, human readable text, binary code, encrypted code, read only code, or the like. One skilled in the art will recognize other ways to create an identifier.

The identifier is configured to identify an application compatible with the file. In one embodiment, the identifier is a URI that references an external location accessible to the computer 102, the external location supplying the referenced application. In a preferred embodiment, the identifier is a URI that includes an application name and version of the application that created or last modified the file and a web address where the application can be referenced. In another embodiment, the reference module 206 accesses a limited functionality version of the referenced application and prompts the user to purchase a fully functional version of the application. For example, the reference module 206 may reference a light version of the application that created the file that only allows viewing of the file and then prompts the user to purchase one of a number of versions of the application that includes more functions. In another embodiment, the identifier includes just a web address of the application. One skilled in the art will recognize other embodiments of an identifier associated with a file for finding an application compatible with a file.

In one embodiment, the identifier is stored at the beginning of a file. In another embodiment, the identifier is stored at the end of a file. In yet another embodiment, the identifier is stored after an end of file marker in a file. In an alternate embodiment, the identifier is stored external to the file and linked to the file. One skilled in the art will recognize other ways for associating an identifier with a file.

An application that creates a file may include the identification module 202. The application may create the identifier which the identification module 202 includes in the file. In another embodiment, an operating system module may create the identifier. In yet another embodiment the identification module 202 creates the identifier. The operating system may communicate the identifier to the identification module 202 which may store the identifier with the file during a save operation or when an application running on the operating system creates, or modifies the file. One skilled in the art will recognize other suitable ways to create an identifier. The identification module 202 may reside in applications that author files, in the operating system, or the like. The file may reside in memory 106, or the data storage device 110. The file may be located external to the computer 102 and accessible through the computer network 122 or the Internet 130.

The access module 204 is configured to access the identifier in response to selection of the file. In one embodiment, the file is selected by double-clicking an icon linked to the file. In another embodiment, the file is selected using an “open” command. In yet another embodiment, the file is selected using an application not compatible with the file. Another embodiment includes selecting the file with a file management application. One skilled in the art will recognize other embodiments for selecting a file such that the access module 204 accesses the identifier.

In a preferred embodiment, the identifier is accessed prior to opening the file. The access module 204 may access the identifier prior to opening the file with an application registered to open files that have a file extension matching the extension of the file. In an alternate embodiment, the access module 204 may access the identifier in response to selection of the file and failure to locate an application registered with the computer 102 and compatible with the file according to the file extension.

The reference module 206 is configured to reference an application external to the computing device using the identifier. Preferably, the application referenced is the same type of application that created or last modified the file. The reference module 206 may permit various reference operations. For example the reference module 206 may retrieve the application from a web site or location accessible from the computer 102. The reference module 206 may prompt a user to download or order the application through retail purchase or subscription using a website. The reference module 206 may also open a local file using the external application in exchange for a fee or for free. The reference module 206 may present the application name and other pertinent information such as version number to a user. The reference module 206 may alternatively automatically install the referenced application.

In a preferred embodiment, the reference module 206 references a preferred application where the preferred application is the application that created the file. In another embodiment, in addition to referencing the preferred application, the reference module 206 may reference one or more additional applications compatible with the file.

Presently, applications may be installed on a computer 102 and may be configured to open files that are compatible with the application but were not created by the application. For example, a word processing program may be installed on the computer 102. At the time of installation, the word processing application may be configured to open files of other word processing programs and any other file compatible with the installed word processing program. Typically this is done by asking the user installing the program if the user wants the program to open compatible files. The application being installed then assigns extensions of competitor's files to be opened by the application being installed. Alternatively, the assignments are made without user input.

This practice is detrimental to the providers of the competing applications because the user will become accustomed to opening files of competing applications with the newly installed application. Typically, users prefer that the application that created the file be the first application used to open the file. Referencing a preferred application ensures that the application that created the file is referenced/used before other compatible applications registered to open files with the same extension as the file.

In an alternate embodiment, the reference module 206 is configured to open a window in response to the access module 204 accessing the file. The window includes a selection for retrieving the referenced external application. Consequently, when selecting a file causes an error because the extension of the file is unrecognized by the operating system, the window may present an option to retrieve the referenced application in addition to the options currently presented when an application compatible with the file is not found. One currently available option is access to a list of applications corresponding to the file extension. Unfortunately, this list is centrally located on a web site and controlled by the web site owner. Consequently, the central site may not keep up with the constantly changing file extension associations. In addition, such a website is only of use when the file has a known and correct file extension. In contrast, the present invention stores the identifier with the file and allows access to an application compatible with the file when the list of extensions is unavailable or when the file extension is not correct.

In a preferred embodiment, the software code for implementing the identification module 202, the access module 204, and the reference module 206 does not include software code from the referenced application. The software code is independent of the referenced application. In the preferred embodiment, an application compatible with the file is referenced through software code for the operating system rather than through software code of the referenced application.

FIG. 3 is a schematic block diagram illustrating an alternate embodiment of an apparatus 300 for finding an application compatible with a file in accordance with the present invention. The apparatus 300 includes a storage module 302, a pointer module 304, the access module 204, and the reference module 206 loaded into memory 106 in the computer 102.

The storage module 302 is configured to store a plurality of identifiers on the computer 102 in a list or table. Each identifier is configured to identify an application and a location for the application compatible with a file accessible to the apparatus 200. In one embodiment, the storage module 302 stores the identifiers on another computer 124, 128 accessible to the computer 102 through the communications adapter 118. Beneficially, storing the identifiers in a list or table easily facilitates updating the identifiers. For example, if a web address in an identifier is changed, an application could update the identifier with a current web address. One skilled in the art will recognize other locations where the identifiers may be stored that are accessible to the computer 102.

The pointer module 304 is configured to associate a pointer within a file with one of the identifiers managed by the storage module 302. In one embodiment, the pointer is a link to a row in a table where the row may include the identifier that corresponds to an application and a location of an application compatible with the file.

The access module 204 and the reference module 206 may function substantially as described above in relation to the apparatus 200 in FIG. 2. Typically the access module 204 reads the pointer associated with the file. The access module 204 then retrieves the identifier corresponding to the pointer from the storage module 302. Next, the reference module 206 references the application indicated by the identifier. Similar to the apparatus 200 described above, the access module 204 may access the identifier in response to selection of the file and failure to locate an application registered with the computer 102 compatible with the file. In another embodiment, the identifier comprises a URI that references a web address accessible to the computer 102 for accessing the referenced application. In yet another embodiment, the reference module 206 opens a window in response to accessing the file and the window includes a selection for retrieving the referenced application.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

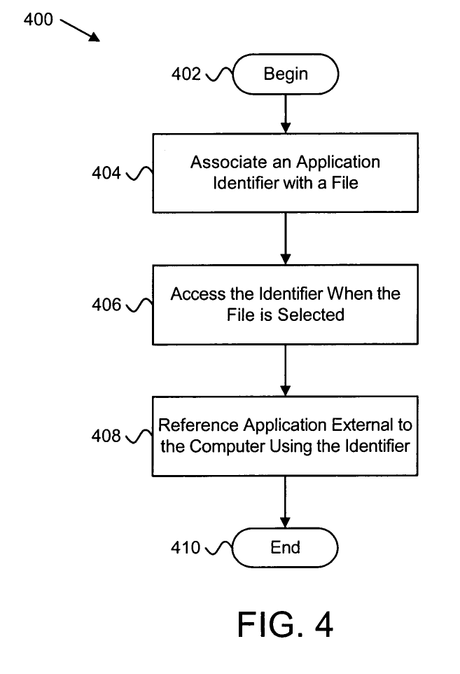

FIG. 4 is a schematic flow chart diagram illustrating one embodiment of a method 400 for finding an application compatible with a file in accordance with the present invention. The method 400 begins 402 and the identification module 202 associates 404 an identifier with a file that resides on or is accessible to the computer 102. The identifier is configured to identify an application compatible with the file. The access module 204 accesses 406 the identifier when the file is selected. Alternatively, the access module 204 accesses the identifier upon selection of the file and failure to locate a compatible application. The reference module 206 references 408 the application compatible with the file and external to the computer 102 and the method 400 ends 410.

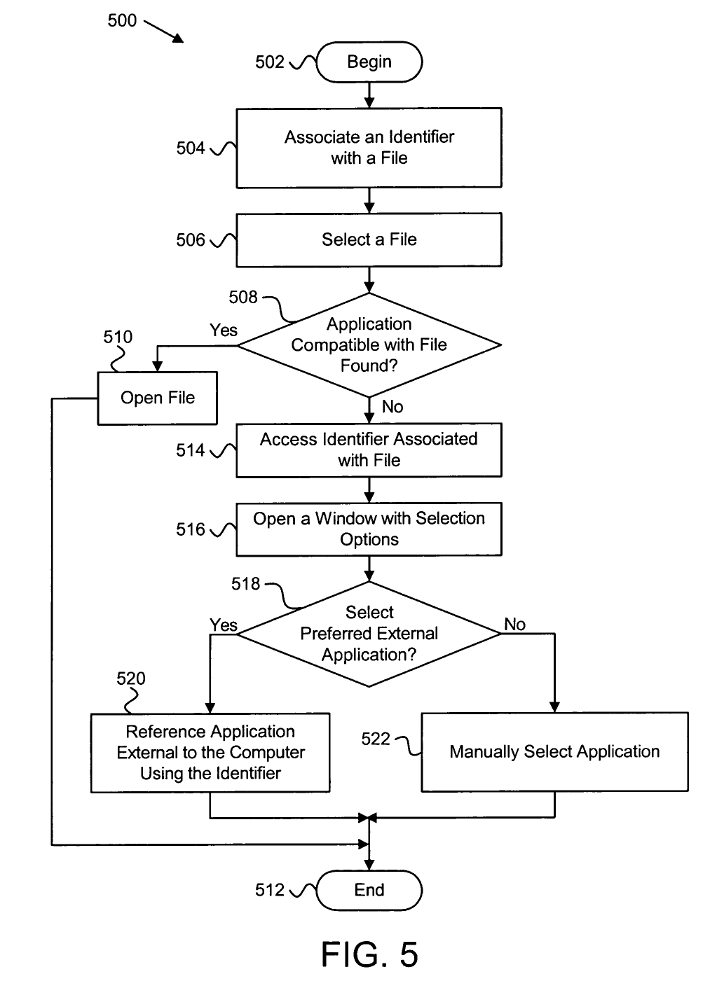

FIG. 5 is a schematic flow chart diagram illustrating an alternate embodiment of a method 500 for finding an application compatible with a file in accordance with the present invention. The method 500 begins 502 and the identification module 202 associates 504 an identifier with a file that resides on or is accessible to the computer 102. A user or the operating system of the computer 102 selects 506 a file.

If the operating system of the computer 102 determines 508 the location of an application compatible with the file, the operating system opens 510 the file and the method 500 ends 512. If the operating system determines 508 there is no application compatible with the file 508, for example using file extensions, the access module 204 accesses 514 the identifier associated with the file.

The reference module 206 then opens 516 a window and presents options for opening the file. If the user selects 518 a preferred application option, the reference module 206 uses the identifier to reference 520 the application external to the computer 102. Then, the method 500 ends 512. Referencing the application may take on many forms as described above in relation to the apparatus. 200 in FIG. 2. Preferably, the identifier is used to open a website featuring the preferred application. If the user does not select 518 the preferred external application, the operating system allows the user to select 522 an application manually.

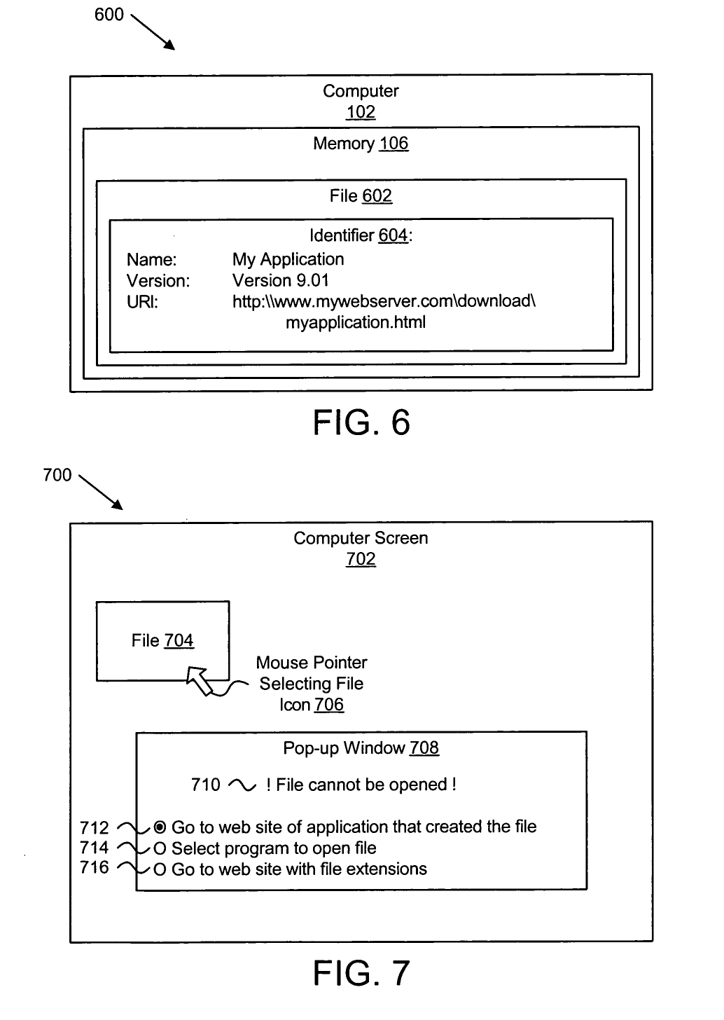

FIG. 6 is a block diagram illustrating an example 600 of one embodiment of an identifier in accordance with the present invention. In the example 600, a file 602 is located in the memory 106 of the computer 102. The identification module 202 stores an identifier 604 in the file 602. In this example 600, the identifier 604 includes a name, “My Application”, a version, “Version 9.01”, and a URI. In this example 600, the URI is a web address http://www.mywebserver.com\download\myapplication.html. In another embodiment, the identifier 604 may include only a web address. One skilled in the art will recognize other embodiments of the identifier 604 for finding an application compatible with a file.

FIG. 7 is a block diagram illustrating one embodiment of a display 700 for retrieving a referenced application in accordance with the present invention. The display 700 includes a computer screen 702 for the computer 102. The display 700 depicts an icon 704 for the file 602 and a mouse pointer 706 selecting the file icon 704.

In response to a user or an application selecting the file 602 and the operating system failing to find a compatible application, the access module 204 accesses the identifier 604. The reference module 206 then displays a pop-up window 708 with an error message 710 that the file 602 cannot be opened or a similar message. In addition, three options are presented to the user. The first option 712 is to go to a web site that allows the user to retrieve the application identified by the identifier 604. The second option 714 is to allow the user to manually select a program to open the file 602. The third option 716 is to go to a web site that includes a central list of file extensions and associated applications. By presenting the first option 712, in conventional operating systems, if no compatible application is found, a user may select a web site to retrieve an application compatible with the file. Specifically, a website for the application that created the file can be referenced.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for finding an application compatible with a file, the apparatus comprising:
an identification module configured to associate an identifier with a file within a computing device, the identifier configured to identify an application compatible with the file;
an access module configured to access the identifier in response to selection of the file; and
a reference module configured to reference an application external to the computing device using the identifier.

2. The apparatus of claim 1, wherein the access module is further configured to access the identifier in response to selection of the file and failure to locate an application registered with the computing device and compatible with the file.

3. The apparatus of claim 1, wherein the reference module is further configured to prompt a user to obtain the referenced application.

4. The apparatus of claim 1, wherein the reference module is further configured to automatically install the referenced application.

5. The apparatus of claim 1, wherein the reference module is further configured to open the file with the referenced application.

6. The apparatus of claim 1, wherein code for implementing the identification module, the access module, and the reference module is free from code of the referenced application.

7. The apparatus of claim 1, wherein the referenced application comprises a preferred application.

8. The apparatus of claim 7, wherein the reference module is further configured to reference a second application compatible with the file in addition to the preferred application using the identifier.

9. The apparatus of claim 1, wherein the identifier comprises a Uniform Resource Identifier (“URI”).

10. The apparatus of claim 9, wherein the URI references an external location accessible to the computing device, the external location supplying the referenced application.

11. The apparatus of claim 1, wherein the reference module is further configured to open a window in response to the access module accessing the file, the window including a selection for retrieving the referenced application.

12. An apparatus for finding an application compatible with a file, the apparatus comprising:
a storage module configured to store a plurality of identifiers on a computing device, each identifier configured to identify an application and a location for the application compatible with a file;
a pointer module configured to associate a pointer within a file with one of the identifiers external to the file;
an access module configured to read the pointer and access the associated identifier in response to selection of the file; and
a reference module configured to reference an application external to the computing device and using the identifier.

13. The apparatus of claim 12, wherein the access module is further configured to access the identifier in response to selection of the file and failure to locate an application registered with the computing device and compatible with the file.

14. The apparatus of claim 12, wherein the identifier comprises a Uniform Resource Identifier (“URI”) that references a web address accessible to the computing device for accessing the referenced application.

15. The apparatus of claim 12, wherein the reference module is further configured to open a window in response to the access module accessing the file, the window including a selection for retrieving the referenced application.

16. A system for finding an application compatible with a file, the system comprising:
a central processing unit (“CPU”);
a data storage device;
an input/output interface;
a memory comprising,
an identification module configured to associate an identifier with a file within a computing device, the identifier configured to identify an application compatible with the file;
an access module configured to access the identifier in response to selection of the file; and
a reference module configured to reference an application external to the computing device using the identifier; and
a communication bus configured to facilitate communication between the CPU, the memory, the data storage device, and the input/output interface.

17. The system of claim 16, wherein the access module is further configured to access the identifier in response to selection of the file and failure to locate an application registered with the computing device and compatible with the file.

18. The system of claim 16, further comprising a communications adapter coupled to the communication bus and configured to communicate with a repository for the referenced application.

19. The system of claim 16, wherein the identifier comprises a Uniform Resource Identifier (“URI”) for referencing an external location accessible to the computing device, the external location supplying the referenced application.

20. The system of claim 16, wherein the reference module is further configured to open a window in response to the access module accessing the file, the window including a selection for retrieving the referenced application.

21. A signal bearing medium tangibly embodying a program of machine-readable instructions executable by a digital processing apparatus to perform an operation for finding an application compatible with a file, the operation comprising:
associating an identifier with a file within a computing device, the identifier configured to identify an application compatible with the file;
accessing the identifier in response to selection of the file; and
referencing an application external to the computing device using the identifier.

22. The signal bearing medium of claim 21, wherein accessing the identifier further comprises an operation to access the identifier in response to selection of the file and failure to locate an application registered with the computing device and compatible with the file.

23. The signal bearing medium of claim 21, wherein referencing the application external to the computing device further comprises an operation to prompt a user to obtain the identified application.

24. The signal bearing medium of claim 21, wherein referencing the application external to the computing device further comprises an operation to automatically install the referenced application.

25. The signal bearing medium of claim 21, wherein referencing the application external to the computing device further comprises an operation to open the file with the identified application.

26. The signal bearing medium of claim 21, wherein code for associating an identifier with a file, accessing the identifier, and referencing an application external to the computing device using the identifier is free from code of the referenced application.

27. The signal bearing medium of claim 21, wherein referencing the application external to the computing device comprises referencing a preferred application.

28. The signal bearing medium of claim 27, further comprising referencing a second application compatible with the file in addition to the preferred application.

29. The signal bearing medium of claim 21, wherein the identifier comprises a Uniform Resource Identifier (“URI”).

30. The signal bearing medium of claim 29, wherein the URI references a web address accessible to the computing device for accessing the referenced application.

31. The signal bearing medium of claim 21, wherein referencing the application external to the computing device further comprises opening a window in response to accessing the file, the window including a selection for accessing the referenced application.

32. A method for finding an application compatible with a file, the method comprising:
associating an identifier with a file within a computing device, the identifier configured to identify an application compatible with the file;
accessing the identifier in response to selection of the file; and
referencing an application external to the computing device using the identifier.

33. An apparatus for finding an application compatible with a file, the apparatus comprising:
means for associating an identifier with a file within a computing device, the identifier configured to identify an application compatible with the file;
means for accessing the identifier in response to selection of the file; and
means for referencing an application external to the computing device using the identifier.
